(19) United States
(12) Patent Application Publication
(10) Pub. No.: US 2023/0116415 A1
(43) Pub. Date: Apr. 13, 2023

(54) Method and Apparatus for Eviction of Foreign Particles From the Airways and Nasal Debris from Nostrils

(71) Applicant: CHANDRASEKHAR BABU GEDDAM, Atlanta, GA (US)

(72) Inventor: CHANDRASEKHAR BABU GEDDAM, Atlanta, GA (US)

(21) Appl. No.: 17/913,652

(22) PCT Filed: Mar. 22, 2021
(86) PCT No.: PCT/US2021/023528

§ 371 Date: Sep. 22, 2022

Related U.S. Application Data
(60) Provisional application No. 62/993,182, filed on Mar. 23, 2020.

(51) Int. Cl. A62B 23/06; A62B 18/02

(52) U.S. Cl. CPC A62B 23/06; A62B 18/025

(57) ABSTRACT

A method and apparatus for assisting in the removal of foreign particles from the airways and nasal debris from the nostrils of a user are described. The device can be used to prevent the spread of disease or may be used as a safety device to assist in the removal of contaminants or other foreign materials that might be encountered by a user.

The present disclosure generally relates to a method and apparatus for assisting in the removal of foreign particles from the airways and nasal debris from the nostrils of a user. The device as described can be used to prevent the spread of disease or as a safety device to assist in the removal of contaminants or other foreign materials that might be encountered by a user.

Many infectious diseases such as influenza, sinusitis, pharyngitis, epiglottitis, laryngotracheitis, and the common cold are spread through person-to-person contact. Viruses such as influenza can cause inflammation, runny nose, coughing, and sneezing. Coughing and sneezing is the body's natural response to rid itself of such irritants. These irritants stimulate nerves which, in-turn, signal the brain. The brain then sends a signal to contract muscles in the chest and abdomen, particularly the diaphragm, to push air out of the lungs to expel and get rid of the irritants. However, this process does not get rid of foreign particles completely. There are no medical solutions for curing such diseases and any microbes left behind can all these diseases to continue to grow in the infected person. The only way to prevent viral and bacterial infections currently is through vaccinations which only works prior to infection. The symptoms caused by the disease can cause an infected person to then infect others.

An objective of the present design is to provide the user with an apparatus for evacuating and storing foreign particles from the upper respiratory system to prevent infectious disease. The present invention comprises a pouch into which the user may apply a method as described herein to flush out foreign particles such as viruses, bacteria, allergens, etc. More specifically, the method comprises the steps of closing the eyes, ears, mouth, and a nostril of the user with the help of the hands and breathing out forcefully through an open nostril. The process may be repeated by closing the opposite nostril. The method may be repeated a number of times to remove as much foreign matter as possible.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the Figures are not necessarily drawn to scale. Throughout this disclosure, depending on the context, singular and plural terminology may be used interchangeably.

FIG. 1 is a rear perspective view of a first embodiment of the device as described.

FIG. 2 is a rear view of the device of the first embodiment.

FIG. 3 is an exploded view of the device of the first embodiment.

FIG. 4 is a front view of device as described exemplifying the utility of the device.

FIG. 5 is a top right perspective view of a second embodiment of the device as described.

FIG. 6 is a front view of a second embodiment of the device as described.

FIG. 7 is a rear view of a second embodiment of the device as described.

FIG. 8 is a side view of a second embodiment of the device as described.

FIG. 9 is an exploded view of the device of the second embodiment.

FIG. 10 is a top right perspective view of a third embodiment of the device as described including adhesive members.

FIG. 11 is a rear view of a third embodiment of the device as described.

FIG. 12 is a front view of a third embodiment of the device as described.

FIG. 13 is a cross sectional view of a third embodiment of the device as described showing the reservoir.

### DETAIL DESCRIPTIONS OF THE INVENTION

The following discussion is directed to various embodiments of the invention. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. Finally, one skilled in the art will understand that the following description has broad application, and the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not structure or function.

As used in the following discussion and in the claims, the terms “including” “is”, “comprising”, “containing”, etc. are used in an open-ended fashion, and thus, should be interpreted to mean “including, but not limited to.” If closed language is included, “consisting,” and “consisting essentially of,” it should be given its art recognized meaning.

A device and method for evacuating and containing foreign particles from the upper respiratory system are described. Foreign particles can include, for example, viruses, bacteria, allergens, dust, contaminants, smoke, soot, or any other foreign matter that may contact the user's airway.

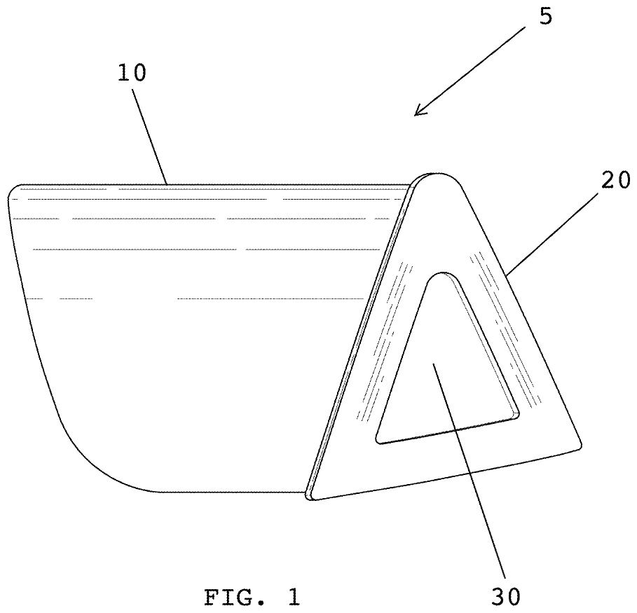

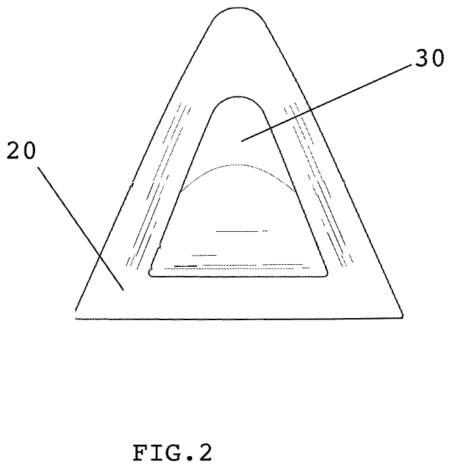

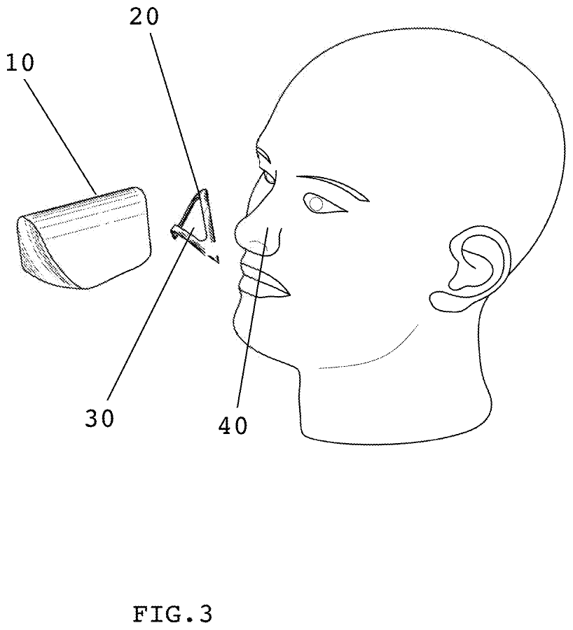

The device 5, as seen in FIG. 1, includes a body member 10 and a cap member 20 having an opening 30 through which the nose of the user may fit. As seen in FIG. 2, in one embodiment, the opening 30 is configured to mimic the shape of the human nose. As seen in the exploded view of FIG. 3, the device may comprise a body member 10, which may be a single piece or multiple pieces sewn or glued together, to form a receptacle. In the embodiment shown, the cap member 20 is affixed to the body member to form the device.

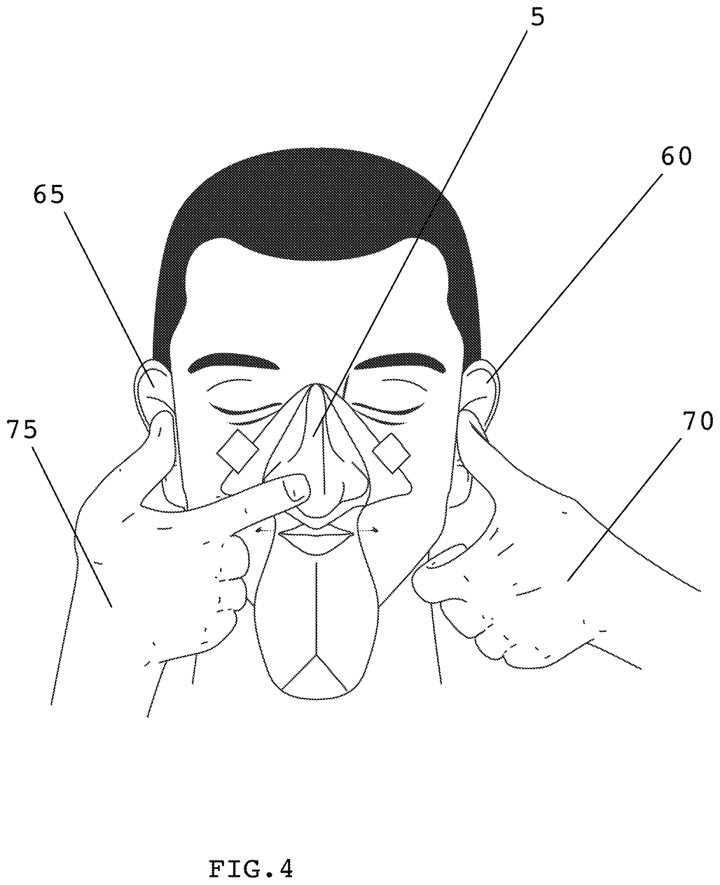

The manner of using the device as described comprises the following steps wherein the final result is conveyed in FIG. 4. The user must first introduce the nose into the open proximal end of device 5. The cap member is placed over the nose. The cap member may be secured to the face using adhesive members, if desired. The user must make sure that the body member 10 is positioned parallel to the nostrils. The hands of the user are raised towards the face where the fingers are oriented towards the front of the head. The user may then use the left hand 70 to cover the left ear 60 and plug the ear canal and the right hand 75 to cover the right ear 65 and plug the ear canal. More specifically, the left thumb is introduced into the left ear canal. The right thumb is introduced into the right ear canal. The user may then use the left index finger to close the left nostril. This may be done by pressing the left nose wing against the septum. The goal of this step is to prevent air from passing through the left nostril and concentrating the flow through the right nostril. The user may then close the eyes and mouth to prevent air flow through the mouth. Next, the user forcefully exhales through the right nostril. The user may release the left wing of the nose and press the right wing of the nose against the septum using the left index finger. The user then forcefully exhales through the left nostril while the eyes, mouth, and ears are closed off. These steps may be repeated in any order and in any number desired. The exhaling process may take one to two minutes.

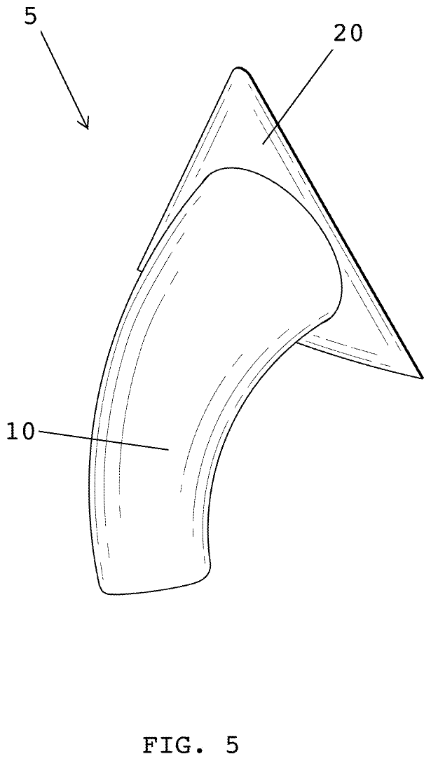

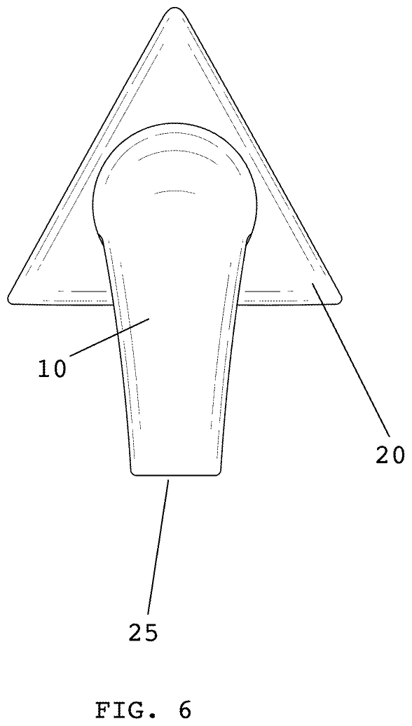

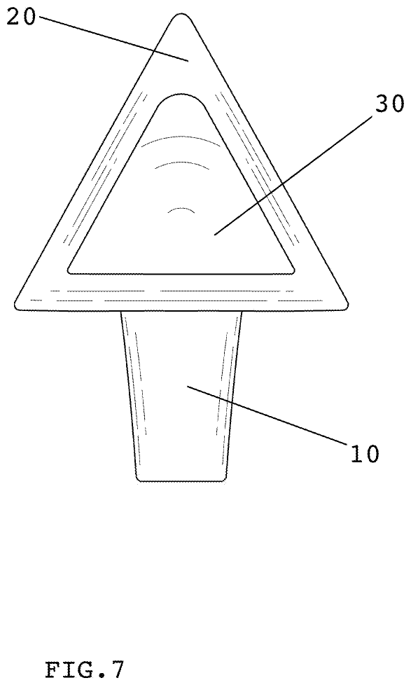

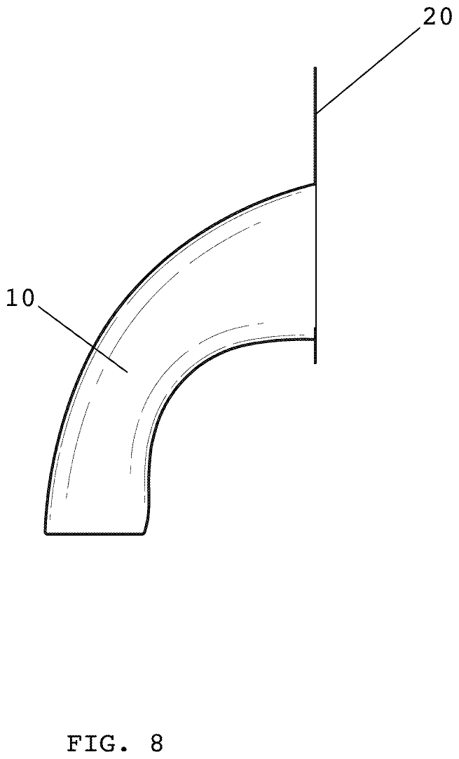

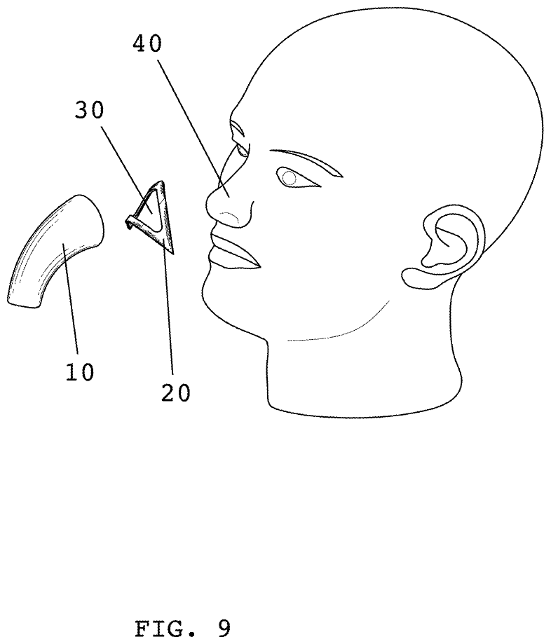

A second embodiment as described can be seen in FIGS. 5-9. This embodiment also comprises a body member 10 and a cap member 20, but in the embodiment, the shape of the body member is circular in cross-section, for example, resembling an elephant's trunk. The end of the body member may be glued shut or may have a second cap member affixed thereto. The elongated shape of this body member may assist in trapping foreign particles in the body member thereby preventing them from returning to the nose or face of the user.

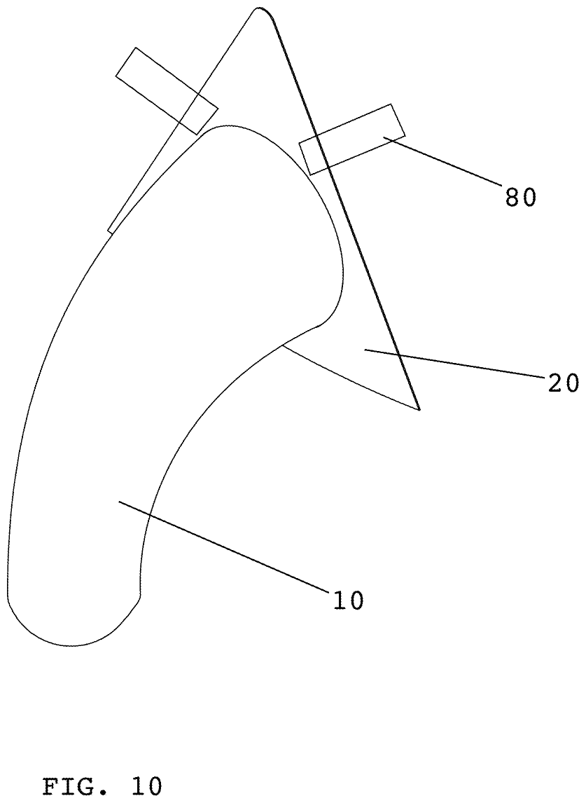

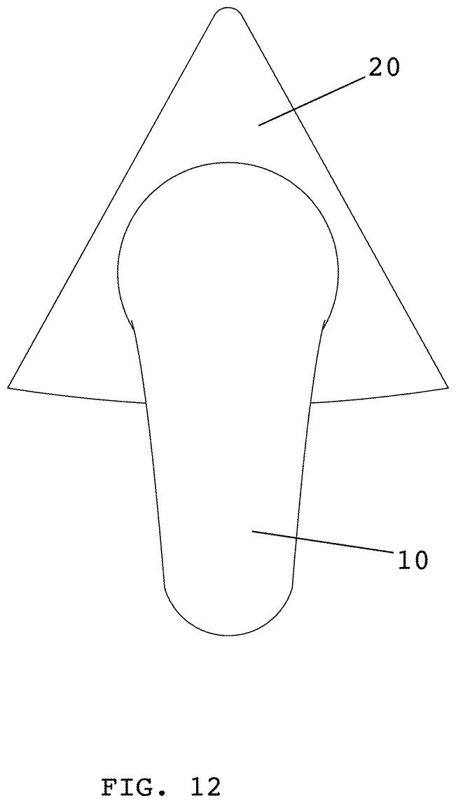

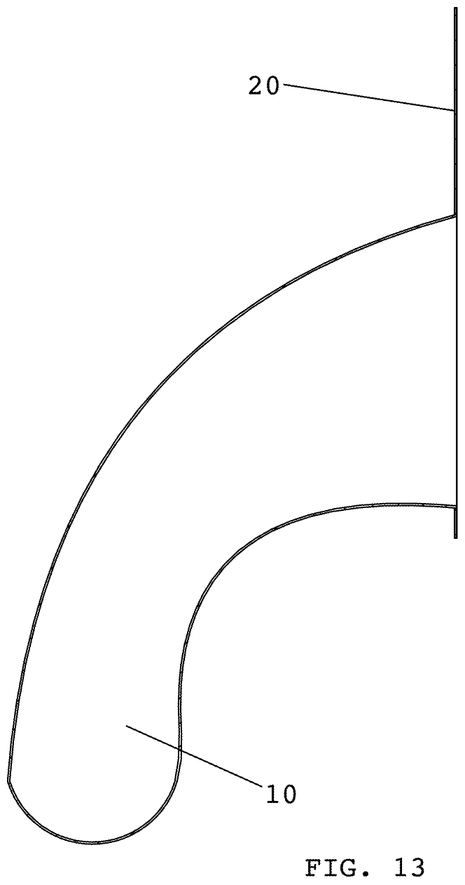

The third embodiment as described can be seen in FIGS. 10-13. This embodiment comprises a first flange (left side) 90 and a second flange (right side) 95 as part of the end cap 20, a tubular body 10, and adhesive tape 80 as seen in FIG. 10. The first flange 90 and the second flange 95 are the two halves of the end cap 20 positioned on either side of the nose and delineate an end of the tubular body. More specifically, the first flange and the second flange connect to an open proximal end 30 of the tubular body 10 and allow the apparatus to attach to the face via adhesive tape. The first flange and the second flange are configured to be placed near the bridge of the nose and angle out towards the sides of the nose while not imposing on the mouth. The first flange, the second flange, and the open proximal end 30 may be contoured by the user to securely and anatomically encapsulate the nose. The flanges and the tubular body may be formed as a continuous piece of an elastic material such as plastic, silicone, paper or other biocompatible material. In one variation of this embodiment, the adhesive tape 80 may be removed from the face of the user and the cap member 20 may be pinched together to close the opening 30. In this variation, the adhesive tape 80 may also be used to secure the cap member 20 to prevent the device 5 from reopening prior to disposal.

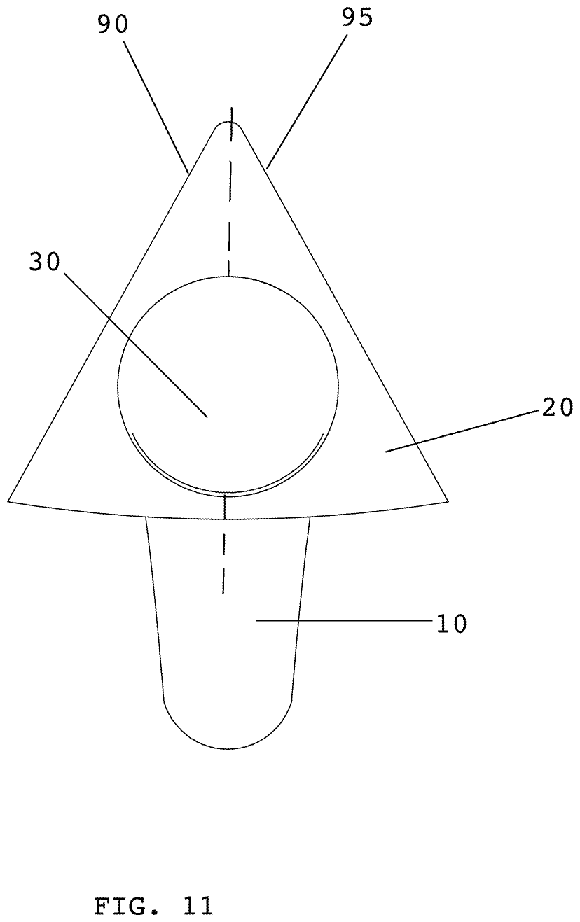

In this embodiment, the tubular body 10 comprises a closed distal end, an open proximal end 30, a neck, and a reservoir as conveyed in FIGS. 11-13. The closed distal end of the tubular body is positioned opposite of the open proximal end. The neck traverses from the closed distal end to the open proximal end. The neck may taper down from the closed distal end to the open proximal end. The taper defines a reservoir traversing the open proximal end towards the closed distal end. The taper of the neck inhibits expelled particles trapped in the reservoir from reversing in direction of flow towards the user.

In an alternate configuration of this embodiment, adhesive tape may be removed and instead the present invention may be held against the nose by the fingers of the user.

According to one embodiment, the body member 10 may include one or more additives that will interact with the foreign particles. The interior surface of the body member may be treated or coated with one or more solutions that are antibacterial or antiviral to neutralize pathogens. In another embodiment, the interior surface may be coated with a material that has a high coefficient of friction causing the foreign particles to contract the device becoming entrapped, thereby minimizing any recontact between the foreign particles and the user.

According to another embodiment (not shown), the cap member 20 may further comprise one or more closing mechanisms, which allow the opening 30 to be sealed prior to disposal. Closing mechanisms may include, for example, a flap that covers and secures the opening 30; an adhesive strip inside the body member that may be pinched together and sealed to close opening 30; adhesive tape strips that may be integral with the product or added that after securing the device to face can be sued to secure opening 30 after it has been pinched closed.

Referring to the embodiment of FIG. 3, another variant (not pictured), would be to replace the end cap 20 with an elastic banding member that would cause the opening 30 to be expandable. In use, the user would expand the elastic band and place the body member over the nose, carry out the described exhalation method, remove the device from the nose, and allow the elastic band to retract thereby partially or substantially closing the opening 30. In such an embodiment, tab members could be added to the device to make the expansion of the elastic band easier for the user. While described with respect to the embodiment of FIG. 3, this variant could be applied to any of the embodiments described herein.

Although the invention has been explained in relation to its preferred embodiments, it is to be understood that many other possible modifications and variations can be made without departing from the spirit and scope of the invention.

1-3. (canceled)

4. A device for removing particles from an airway of a user comprising:
a body member for collecting particles from the airway of a user;
a cap member or elastic band attached to the body member comprising an opening that is configured to fit over a nose of the user; and
a closing mechanism.

5. The device of claim 4, wherein the closing mechanism is chosen from a flap to cover the opening and an adhesive strip in the body member.

6. The device of claim 4, further comprising an antibacterial or antiviral coating on an interior of the body member.

7. The device of claim 4, wherein the body member is attached to the cap member.

8. A method for using the device of claim 4, comprising:
covering a left ear of the user with a left thumb
covering a right ear of the user with a right thumb;
closing a left nostril with a left index finger;
closing a mouth and forcefully exhaling through a right nostril into the device;
releasing the left nostril;
closing the right nostril with a right index finger;
closing the mouth and forcefully exhaling through the left nostril into the device.
releasing the right nostril.

9. The method of claim 8, wherein the exhalation steps are carried out more than once.

10. The method of claim 8, further comprising the step of closing and securing the device opening before disposing of the device.
